(19) United States
(12) Patent Application Publication
(10) Pub. No.: US 2018/0316634 A1
(43) Pub. Date: Nov. 1, 2018

(54) EXTENDING APPLICATION FUNCTIONALITY VIA CONVERSATIONAL INTERFACES

(71) Applicant: Microsoft Technology Licensing, LLC, Redmond, WA (US)

(72) Inventors: Daniel J. Driscoll, Seattle, WA (US); Anthony D. Andrews, Bellevue, WA (US); Ali N. Alvi, Kirkland, WA (US); Yuan-Chun Chiu, Redmond, WA (US)

(21) Appl. No.: 15/498,223

(22) Filed: Apr. 26, 2017

(51) Int. Cl. H04L 12/58; H04L 29/08; G06F 9/54

(52) U.S. Cl. CPC H04L 51/04; G06F 9/541; H04L 51/066; H04L 67/141

(57) ABSTRACT

Systems and methods are disclosed for extending application functionality via conversational interfaces. In one implementation, a first communication is received from an interaction engine. The first communication is processed to identify an application that the communication is directed to, The first communication is provided to an application extension engine associated with the first application. A second communication is received from the application extension engine. The second communication is provided to the interaction engine.

### TECHNICAL FIELD

Aspects and implementations of the present disclosure relate to data processing and, more specifically, but without limitation, to extending application functionality via conversational interfaces.

### BACKGROUND

In order to access functionality provided by various applications or services (e.g., via mobile devices such as smartphones), such applications/services can provide downloadable applications or ‘apps.’ Users can then access functionality provided by an application/service by launching a corresponding ‘app’ on the user's device.

### SUMMARY

The following presents a shortened summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a compact form as a prelude to the more detailed description that is presented later.

In one aspect of the present disclosure, systems and methods are disclosed for extending application functionality via conversational interfaces. In one implementation, a first communication is received from an interaction engine. The first communication is processed to identify an application that the communication is directed to. The first communication is provided to an application extension engine associated with the first application. A second communication is received from the application extension engine. The second communication is provided to the interaction engine.

In another implementation, a first communication directed to an application is received. The first communication is formatted in accordance with an API of the application. The first communication, as formatted, is provided in accordance with the API, to the application. A second communication is received from the application. The second communication is provided in response to the first communication.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIGS. 2A-2D illustrate example scenarios described herein, according to example embodiments.

FIG. 3 illustrates another example system, in accordance with an example embodiment.

FIGS. 4A and 4B illustrate example scenarios described herein, according to example embodiments.

FIG. 5 is a flow chart illustrating a method, in accordance with an example embodiment, for extending application functionality via conversational interfaces.

FIG. 6 is a flow chart illustrating a method, in accordance with another example embodiment, for extending application functionality via conversational interfaces.

FIG. 7 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to extending application functionality via conversational interfaces.

Various applications and services (such as those deployed across one or more servers or within a ‘cloud’ framework) can provide functionality to end users through downloadable applications or ‘apps.’ For example, many applications and services provide dedicated mobile apps that can be installed on mobile devices smartphones, tablet computers, etc.). Once such an app is installed, a user can access functionality provided by an application/service by launching/running the mobile app on the device. However, developing mobile apps for multiple platforms can be expensive and time consuming. As a result, dedicated mobile apps are often not available for certain platforms.

Accordingly, described herein in various implementations are technologies, including methods, machine readable mediums, and systems, that extend application functionality (e.g., in lieu of utilizing a dedicated mobile app associated with such an application). As described herein, the described technologies provide the functionality, features, etc. of such services/applications via an interaction engine (e.g., a conversational interface such as an intelligent personal assistant, chat interface, etc.). In certain implementations, a communication coordination engine can relay/route communication(s) between such a conversational interface and a server at which the desired service/application is implemented. For example, a user communication received via a chat interface can be processed to identify an application/service to which it is directed. The communication can then be formatted in accordance with an application programming interface (API) associated with the identified application/service, and relayed to the application/service itself. Subsequent communication(s) provided in response by the application/service can be formatted in accordance with a conversational (e.g., chat) API and relayed back to the conversational interface for presentation to the user. In doing so, many aspects of the functionality, features, etc. of the service/application can be provided via the conversational interface, without the need for a dedicated/standalone ‘app.’

The described approach can be advantageous in numerous scenarios. For example, with respect to devices for which a standalone ‘app’ has not been developed (or cannot be obtained), the described technologies can enable users to access corresponding functionality via an intelligent personal assistant, chat/messaging interface, etc. Additionally, the described technologies can provide the features, functionality, etc., of multiple applications/services via a single conversational interface.

It can therefore be appreciated that the described technologies are directed to and address specific technical challenges and longstanding deficiencies in multiple technical areas, including but not limited to communication interfaces, mobile applications, and intelligent personal assistants. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

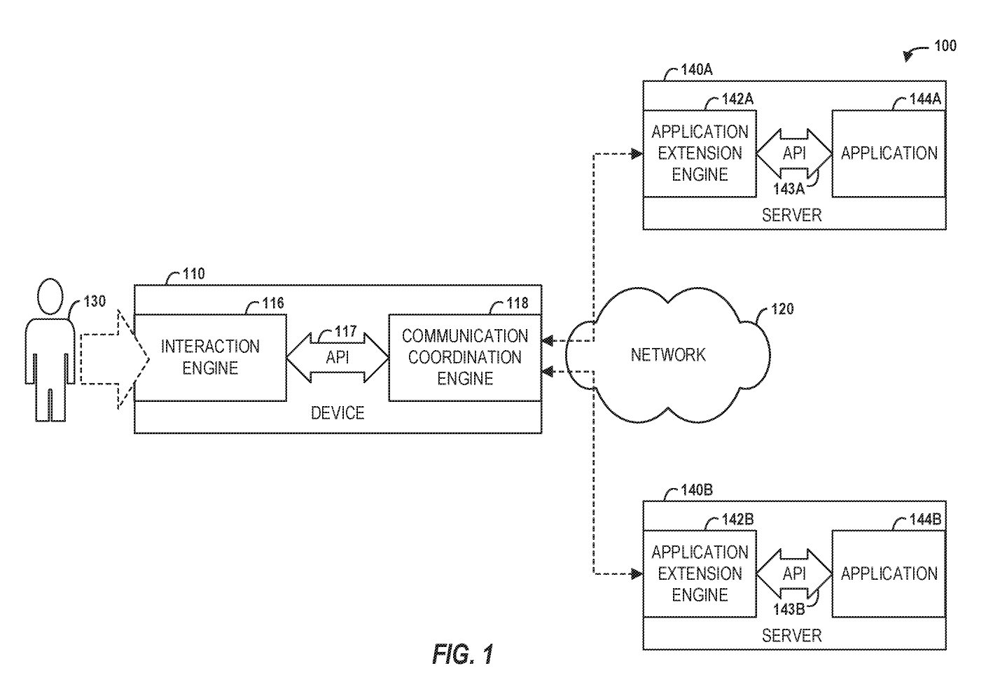

FIG. 1 illustrates an example system 100, in accordance with some implementations. As shown, the system 100 includes device 110 which can be a laptop computer, a desktop computer, a terminal, a mobile phone, a tablet computer, a smart watch, a wearable device, a digital music player, a server, and the like. User 130 can be a human user who interacts with device 110. For example, user 130 can provide various inputs (e.g., via an input device/interface such as a keyboard, mouse, touchscreen, etc.) to device 110. Device 110 can also display, project, and/or otherwise provide content to user 130 (e.g., via output components such as a screen, speaker, etc.).

As shown in FIG. 1, device 110 can include interaction engine 116. Interaction engine 116 can be an application or module that configures/enables the device to interact with, provide content to, and/or otherwise perform operations on behalf of user 130. For example, interaction engine 116 can receive communications and/or request(s) from user 130 and present/provide responses to such request(s) (e.g., within a conversational or ‘chat’ interface). Examples of interaction engine 116 include but are not limited to intelligent personal assistants, messaging/communication applications (e.g., chat, instant messaging, etc.) and other applications or interfaces through which a user can send and/or receive messages, content, notifications, and/or other information.

In certain implementations, interaction engine 116 can also enable user 130 to initiate and/or configure other application(s). For example, user 130 can provide a command/communication to interaction engine 116 (e.g., ‘play jazz music’). In response to such command, interaction engine 116 can initiate an application (e.g., a media player application) that fulfills the request provided by the user. Additionally, while in certain implementations various aspects of interaction engine 116 can execute/operate on device 110, in other implementations interaction engine 116 can operate or execute on a remote device (e.g., on a server, as described below).

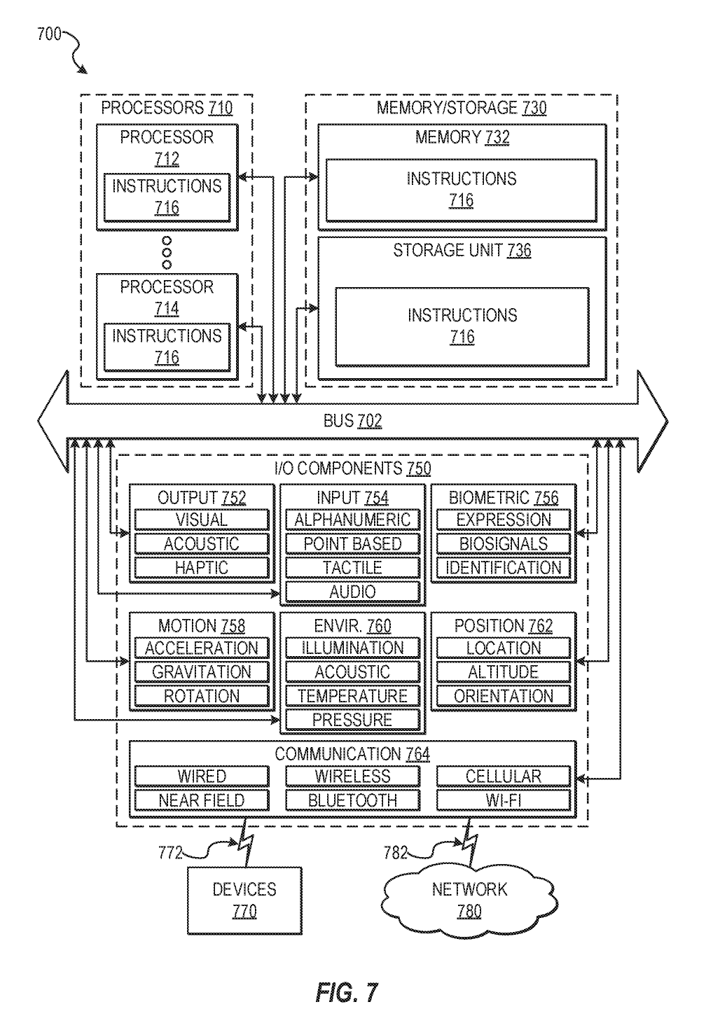

As shown in FIG. 1, device 110 can also include communication coordination engine 118. Communication coordination engine 118 can be an application, program, module, etc., stored in memory of device 110 (e.g. memory 730 as depicted in FIG. 7 and described below). One or more processor(s) of device 110 (e.g., processors 710 as depicted in FIG. 7 and described below) can execute such application(s). In doing so, device 110 can be configured to perform various operations, as described herein.

As shown in FIG. 1, communication coordination engine 118 can be configured to communicate and/or otherwise interact with interaction engine 116. In certain implementations, such communications, interactions, etc. between communication coordination engine 118 and interaction engine 116 can be performed via and/or in accordance with application programming interface (API) 117. API 117 can include, for example, various protocols, definitions, tools, interfaces, libraries, frameworks, etc. through which communications are sent to and/or received from interaction engine 116. By way of illustration, API 117 can include and/or reflect a conversational (e.g., chat/messaging) API that defines the manner in which communications can be provided for presentation within interaction engine 116.

It should also be noted that while various components (e.g., interaction engine 116, communication coordination engine 118, etc.) are depicted (e.g., in FIG. 1) as operating on a device 110, this is only for the sake of clarity. However, in other implementations the referenced components (e.g., communication coordination engine 118) can also be implemented on other devices/machines. For example, in lieu of executing locally at device 110, communication coordination engine 118 can be implemented remotely (e.g., on a server device or within a cloud service or framework).

As also shown in FIG. 1, device 110 can connect to and/or otherwise communicate with other devices/machines via network 120. Network 120 can include one or more networks such as the Internet, a wide area network (WAN), a local area network (LAN), a virtual private network (VPN), an intranet, and the like. As shown in FIG. 1, device 110 can communicate with server 140A and server 140B (collectively, servers 140). Each server can be, for example, a server computer, computing device, storage service (e.g., a ‘cloud’ service), etc.

Each server can include an application such as application 144A and application 144B, respectively (collectively applications 144). Each application can be a program, module, set of instructions etc. stored on and/or executed by the server. The application can configure the server to provide various services, such as via communications to/from device 110. By way of illustration, application 144A can be an application that configures server 140A to provide a taxi dispatch service through which taxis can be dispatched in response to user requests/communications. By way of further illustration, application 144B can be an application that configures server 140B to provide a food delivery service through which restaurant orders can be placed in response to user requests/communications. It should be understood that the referenced applications/services are provided only by way of example and that any number of other applications, services, etc. can also be implemented in the manner described herein.

As also shown in FIG. 1, server 140A and server 140B can also include application extension engine 142A and application extension engine 142B, respectively (collectively, application extension engines 142). Each application extension engine can be a program, module, set of instructions etc. that extend various capabilities, functionality, etc., of an application. For example, an application extension engine can extend capabilities of a corresponding application with respect to the manner in which communication(s), requests, responses, etc. are provided to/from the application. As also shown in FIG. 1, application extension engines 142 can be configured to communicate and/or otherwise interact with applications 144. In certain implementations, such communications, interactions, etc. between an application extension engine and a respective application can be performed via and/or in accordance with an application programming interface (API) such as API 143A or API 143B (collectively, APIs 143). APIs 143 can include, for example, various protocols, definitions, tools, interfaces, libraries, frameworks, etc. through which communications are sent to and/or received from applications 144.

By way of illustration, in a scenario in which application 144A is an application that provides a taxi dispatch service, API 143A can define the manner, format, protocols, etc. in which communications (e.g., requests for taxi pickup at a location, booking confirmations, etc. are provided to/received from application 144A. Accordingly, application extension engine 142A can, for example, receive a communication originating from a conversational interface (e.g., interaction engine 116) and format such a communication such that the communication can be provided to application 144A in accordance with API 143A. In doing so, the application extension engine (e.g., application extension engine 142A) enables communication(s) originating from other sources/contexts (such as interaction engine 116) to be provided to the corresponding application (e.g., application 144A). The application extension engine also enables communication(s) originating from the corresponding application to be provided to other applications (such as interaction engine 116).

It should be note that while FIG. 1 depicts application extension engines 142 executing on servers 140A and 140B, this reflects only one example implementation. However, in other implementations application extension engines 142 can, for example, he configured to execute at device 110 and/or on another machine, device, server, etc.

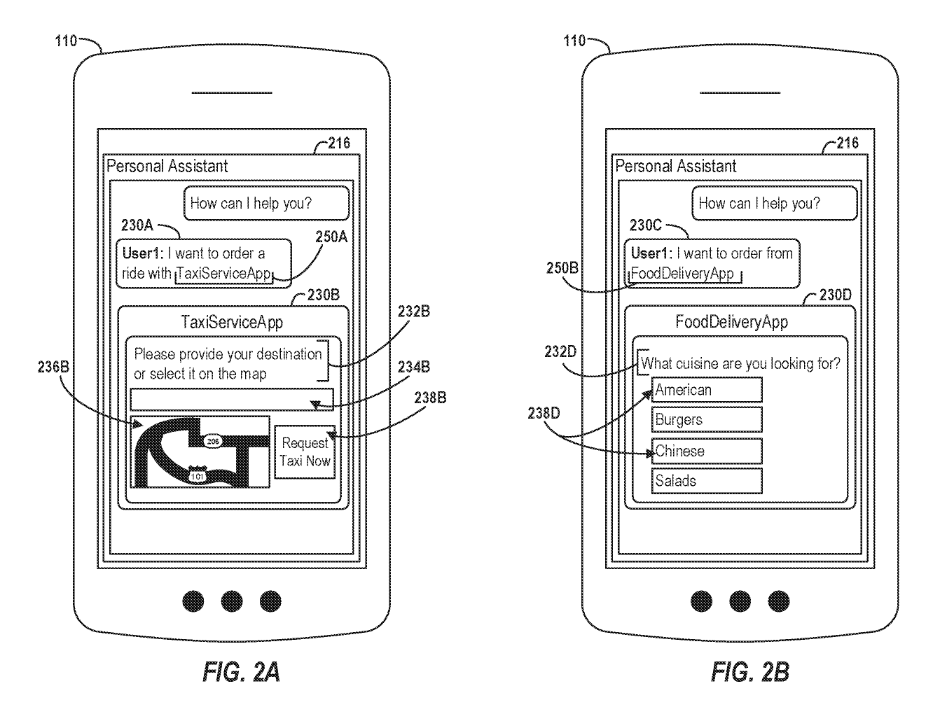

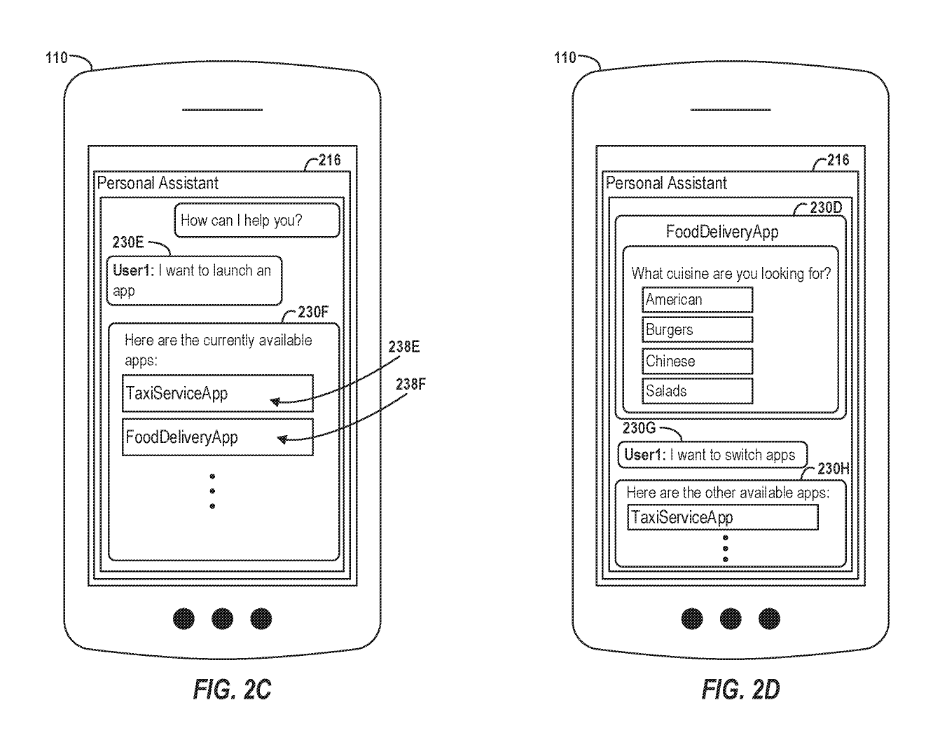

Further aspects and features of device 110 and server 140 are described in more detail in conjunction with FIGS. 2A-7, below.

By way of further illustration, FIG. 2A depicts an example scenario in which interaction engine 216 (here, a personal assistant application/communication interface) is executing on (or otherwise presented/provided at) device 110. As shown in FIG. 2A, user 130 (‘User1’) can provide or input communication/message 230A (“I want to order a ride . . . . ”) to interaction engine 216. Communication 230A can then be processed (e.g., using natural language processing and/or other such techniques) to parse or otherwise analyze the received communication. In doing so, various content element(s) (e.g., words, identifiers, etc.) can be extracted/identified. Such content elements can, for example, correspond to an application, service, etc., that the user wishes to access, initiate, launch, etc. By way of illustration, as shown in FIG. 2A, communication 230A can be processed to identify content element 250A (‘IaxiServiceApp’) which corresponds to an application that the user wishes to access or utilize.

In certain implementations, communication coordination engine 118 can also be initialized by interaction engine 216. For example, FIG. 2C depicts an example scenario in which user 130 (‘User1’) provides communication/message 230E (“I want to launch . . . . ”) to interaction engine 216. Communication 230E can then be processed (e.g., as described herein) to determine that the user wishes to access various available applications/services. In response, communication coordination engine 118 can provide communication 230F, which can include a list of applications/services that can be accessed via communication coordination engine 118. For example, as shown in FIG. 2C, selectable controls 238E and 238F (e.g., button(s) a user can interact with, activate, etc., as described below) corresponding to TaxiServiceApp and FoodDeliveryApp, respectively, can be presented. In certain implementations, communication coordination engine 118 can generate the referenced list of applications by polling or querying server(s) 140 and/or application(s) 144 to identify those that are presently accessible, e.g., via network 120. User 130 can then select one of the referenced controls in order to access functionality, features, etc. of the corresponding application/service, as described in detail herein.

Moreover, in certain implementations, upon accessing a first application/service (e.g., within interaction engine 116, as described herein), a user can later decide to change or switch to another application/service. For example, FIG. 2D depicts an example scenario in which user 130 (‘User1’) has initially accessed functionality from a first application (here, ‘FoodDeliveryApp,’ as depicted in communication 230D within interaction engine 216). Subsequently, user 130 can provide communication 230G (“I want to switch . . . . ”) to interaction engine 216. Communication 230G can then be processed (e.g., as described herein) to determine that the user wishes to access another application/service. In response, communication coordination engine 118 can provide communication 230H, which can include various application(s)/service(s) that can be accessed via communication coordination engine 118 (e.g., other than ‘FoodDeliveryApp,’ which has already been accessed). For example, as shown in FIG. 2D, communication 230H (containing a selectable control corresponding to ‘TaxiServiceApp’) can be presented. User 130 can then select one of the referenced control(s) in order to access functionality, features, etc. of the corresponding application/service, as described in detail herein. In doing so, communication coordination engine 118 (in conjunction with interaction engine 116) can operation as a launcher-type application, through which a user can review available applications/services, select from among them, and switch/swap between them.

Having identified the application that the user wishes to access, the communication 230A received at interaction engine 216 can be routed, relayed, etc. to the identified application (here, ‘TaxiServiceApp’). In certain implementations, communication coordination engine 118 (as shown in FIG. 1 and described above) can coordinate the relaying, providing, etc. of this communication from the interaction engine to the identified application (e.g., a server 140 on which the application executes).

In certain implementations, supplemental content (e.g., content, information, etc., that is not initially included in the communication as received from the user) can be incorporated into and/or otherwise associated with the communication. For example, prior to relaying communication 230A to the server at which the corresponding application (‘TaxiServiceApp’) is executing, communication coordination engine 118 can incorporate or associate additional/supplemental content, information, etc. By way of illustration, supplemental content such as the current location of device 110, various specifications of the device (e.g., model number), a user account/profile associated with the user, etc. can be incorporated into or associated with communication 230A (and then relayed to the identified application/server). In doing so, subsequent communications with the application can be enhanced and/or streamlined (e.g., by providing content appropriately formatted for the device). It should be understood that, in certain implementations, device 110 and/or interaction engine 116 can be configured to incorporate and/or otherwise provide content such as the supplemental content referenced above.

As shown in FIG, 1, communication coordination engine 118 can transmit, provide, relay, etc. the referenced communication (e.g., communication 230A as shown in FIG. 2A) to server 140A. As noted above, server 140A can be a server on which the application referenced, identified, etc., in the received communication (e.g., ‘TaxiServiceApp’) is executing. In certain implementations, the referenced communication 230A can be provided to/received by application extension engine 142A (which can also execute at server 140A, as noted above).

By, way of illustration, application extension engine 142A can receive communication 230A from communication coordination engine 118 (e.g., via network 120). As noted above, the referenced communication 230A (‘I want to . . . ’) originated from a conversational interface (e.g., interaction engine 216 of FIG. 2A). Accordingly, application extension engine 142A can format such communication 230A such that the communication can be provided to application 144A (here, ‘TaxiServiceApp’) in accordance with API 143A.

Upon receiving the referenced communication, application 144A (‘TaxiServiceApp’ in the scenario depicted in FIG. 2A) can generate another communication (and/or other content). Such content/communication generated by application 144A can be, for example, a response or follow-up communication that provides content related to the initially received communication, prompt(s) that request additional information from the user, etc. By way of illustration, in the scenario depicted in FIG. 2A, upon receiving an initial communication that user wishes to order a taxi ride, application 144A can respond with communication/content that requests the destination associated with the referenced ride. Such a response from application 144A can then be provided back to application extension engine 142A in accordance with API 143A. Application extension engine 142A can then transmit or provide the referenced response (from application 144A) to communication coordination engine 118.

In certain implementations, application extension engine 142A can format or otherwise process the response received from application 144A prior to providing the response to communication coordination engine 118. For example, application extension engine 142A can receive a response/communication from application 144A in accordance with API 143A (e.g., an API associated with taxi service instructions/operations). Application extension engine 142A can then format and/or otherwise modify this communication and provide the formatted/modified communication to coordination engine 118. By way of illustration, the response received from application 144A (which, as noted, is provided/received in accordance with API 143A) can be formatted in accordance with API 117 (e.g., a conversational API associated with presentation of communications within interaction engine 116). Communication coordination engine 118 can then provide the received communication to interaction engine 116 (e.g., an intelligent personal assistant, chat interface, etc.) within which the communication can be presented/provided (e.g., to user 130).

By way of illustration, FIG. 2A depicts communication 230B which can be a message, content, and/or other items presented/provided within interaction engine 216. As described above, various elements of communication 230B can originate from application 144A (here, ‘TaxiServiceApp’), e.g., in response to communication 230A. As shown in FIG. 2A, communication 230B can include elements such as text content 232B, input field 234B (e.g., form within which text or other inputs can be provided), multimedia content 236B (e.g., images, video, etc.), selectable control 238B (e.g., a button that a user can interact with, activate, etc.), and/or other commonly used and. custom elements.

In certain implementations, user 130 can interact with (e.g., click, tap, select, etc. via an input device of device 110 such as a touchscreen) various elements of communication 230B. In doing so, another communication (corresponding to such interaction/selection) can be generated and provided to application 144A (e.g., via communication coordination engine 118 and application extension engine 142A, as described above). For example, user 130 can select a location within multimedia content 236B (here, an interactive map) and then tap, click, etc. selectable control 238B. A communication reflecting such a selection can then be generated and/or provided to application 144A.

It can therefore be appreciated that the described technologies (e.g., communication coordination engine 118 and application extension engine 142A) enable user 130 to access functionality, features, etc. of application 144A via interaction engine 116 (e.g., an intelligent personal assistant, chat interface, etc.). While certain applications/services may provide standalone applications (‘apps’) that execute locally on device 110 and communicate directly with server 144A, the described technologies can provide a comparable experience to the user without a dedicated ‘app’ executing on device 110. As described herein, communication coordination engine 118 relays/routes communications between interaction engine 116 and a remote server on which the desired application/service is implemented. In doing so, user 130 can access the functionality, features, etc. of the service/application via interaction engine 116. In certain implementations, such a server can be owned, operated, controlled, etc. (in whole or in part) by other entities such as application/service providers, developers, etc. (e.g., entities other than the entity that develops/provides communication coordination engine 118). Additionally, the referenced network 120 (through which various communications are transmitted/received) should be understood to be merely illustrative. Accordingly, as noted herein, in certain implementations interaction engine 116, communication coordination engine 118 and/or application extension engine 142A may execute on a device (e.g., a single device) and thus may not necessarily be separated by a physical network.

The described approach can be advantageous in numerous scenarios. For example, with respect to devices for which a standalone ‘app’ has not been developed (or cannot be obtained), the described technologies can enable users to access corresponding functionality via interaction engine 116 (e.g., an intelligent personal assistant, chat/messaging interface, etc.). Additionally, the described technologies can provide the features, functionality, etc., of multiple applications/services via a single interaction engine 116.

For example, as also shown in FIG. 1 and described above, in addition to providing user 130 with access to functionality of application 144A via interaction engine 116 (e.g., as depicted in FIG. 2A), interaction engine 116 can also provide access to other applications, services, etc., such as application 144B.

By way of illustration, FIG. 2B depicts an example scenario in which user 130 (‘User1’) provides communication/message 230C (“I want to order from . . . .”) to interaction engine 216. Communication 230C can then be processed (e.g., as described above with respect to FIG. 2A) to extract/identify content element(s) such as content element 250B (‘FoodDeliveryApp’) that corresponds to an application that the user wishes to access or utilize. Communication coordination engine 118 can then route, relay, etc. communication 230C from interaction engine 216 to a server 140 on which the identified application (‘FoodDeliveryApp’) executes. For example, as shown in FIG. 1, communication coordination engine 118 can transmit, provide, relay, etc. a communication (e.g., communication 230C of FIG. 2B) to server 140B on which the identified application 144B (here, ‘FoodDeliveryApp’) is executing. As described above, in certain implementations application extension engine 142B can format communication 230B such that the communication can be provided to application 144B (‘FoodDeliveryApp’) in accordance with API 143B.

As described in detail above, application 144B (here, ‘FoodDeliveryApp’) can generate a follow-up communication that, for example, prompt(s) the user for additional input (e.g., a cuisine type, price range, etc.). The follow-up communication can then be provided back to application extension engine 142B in accordance with API 143B. Application extension engine 142B can format and/or modify the communication (e.g., in accordance with a conversational API) and then provide the communication to communication coordination engine 118 for presentation to user 130.

For example, as shown in FIG. 2B, communication 230D can originate from application 144B (here, ‘FoodDeliveryApp’), e.g., in response to communication 230C. Communication 230D can include elements such as text content 232D and various selectable controls 238D that user 130 can interact with (e.g., click, tap, etc.). In doing so, additional communication(s) that correspond to such selection(s) can be generated and provided back to application 144B (e.g., via communication coordination engine 118 and application extension engine 142B, as described above). For example, user 130 can select one of controls 238D corresponding to a particular cuisine and a communication reflecting such a selection can be generated and/or provided to application 144B.

Accordingly, the described technologies (e.g., communication coordination engine 118) can enable user 130 to access the respective features, functionalities, etc., of multiple applications/services via interaction engine 116 (e.g., an intelligent personal assistant, messaging interface, etc.). For example, as shown in FIGS. 2A and 2B, a single interaction engine 216 can provide access to both a taxi dispatch application and a food delivery application. It should be understood that the referenced applications, services, etc., are provided for the sake of illustration and that features, etc. of any number of other applications, services, etc., can be accessed in a comparable manner.

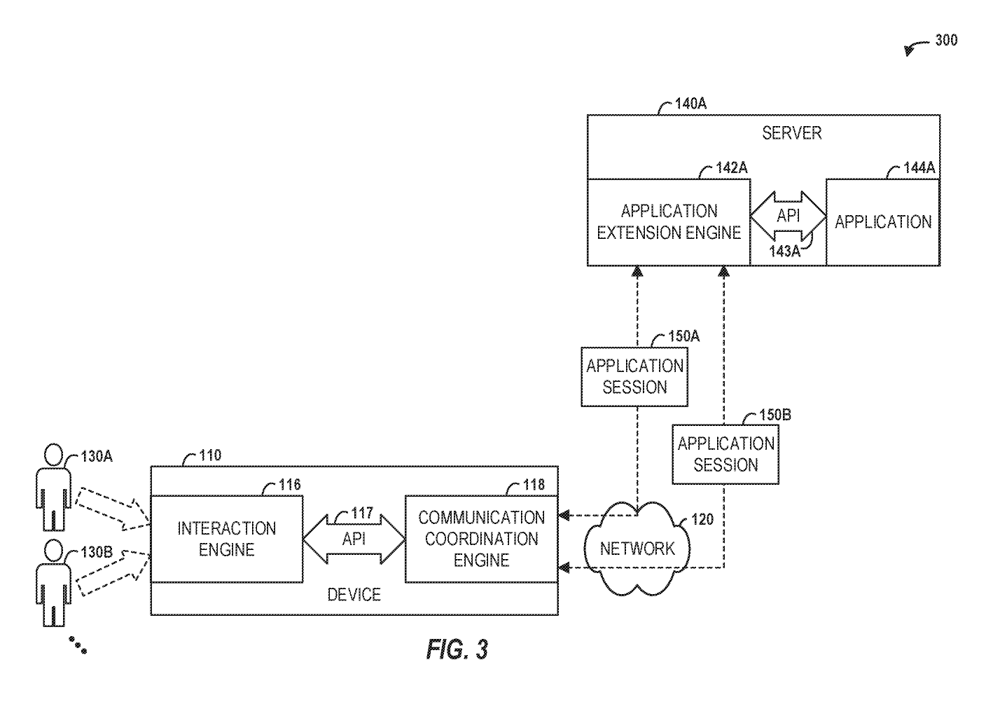

FIG. 3 illustrates another example implementation of various technologies depicted in FIG. 1 and described above. As shown in FIG. 3, two (or more) users, such as user 130A and user 130 can interact with device 110, e.g., via interaction engine 116. For example, interaction engine 116 can be an intelligent personal assistant that can receive voice/audio communications from various users (as perceived, for example, by a microphone of device 110) and/or provide information, content, etc., in visual and/or audio format (e.g., via a speaker of device 110). Accordingly, in certain scenarios (e.g., as shown in FIG. 2) interaction engine 116 can receive communication(s) (e.g., audio/voice inputs) from both user 230A and user 230B during a single communication session, instance, or sequence. It should be noted that, using various audio processing techniques, interaction engine 116 can distinguish those communications (e.g., audio/voice inputs) originating from one user from those originating from another user. For example, various audio characteristics (tone, pitch, etc. can be used to determine which user provided a particular communication. In other implementations, various other authentication/verification techniques can be utilized.

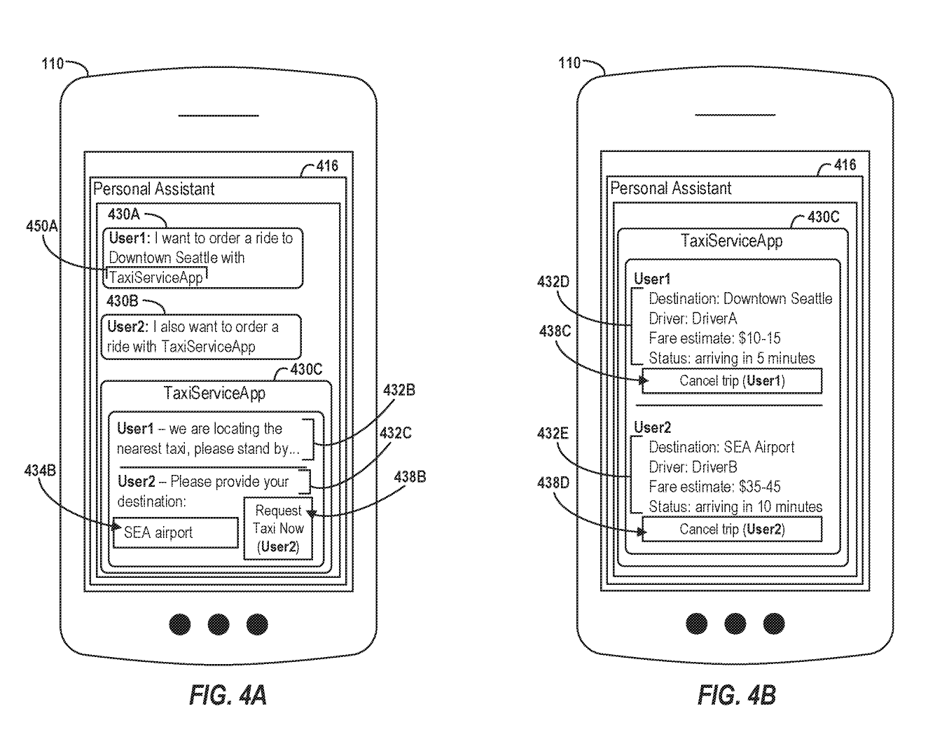

By way of illustration, FIG. 4A depicts an example scenario in which user 130A (‘User1’) provides communication/message 4304 (“I want to order a ride . . . . ”) to interaction engine 416. As also shown in FIG. 4A, user 130B (‘User2’) can provide communication/message 430B (“I also want to . . . .”) to interaction engine 416.

Communication 430A can be processed (e.g., as described above with respect to FIG. 2A) to extract/identify content element(s) such as content element 450A (‘TaxiServiceApp’) that corresponds to an application that the first user wishes to access or utilize. Communication 430B can also be processed in a comparable manner.

Communication coordination engine 118 can then route, relay, etc. communication 4304 and communication 430B from interaction engine 416 to a server 140A on which the identified application 144A (‘TaxiServiceApp’) executes. Additionally, as noted above, in certain implementations coordination engine 118 can incorporate or otherwise associated various supplemental content with the referenced communication(s). Such supplemental content can be content, information, etc., that is not initially included in a communication as received from the user. For example, having determined (e.g., as described above) that interaction engine 416 received communications originating from multiple users and further determining that the respective communications are directed to a single application/service (here, ‘TaxiServiceApp’), communication coordination engine 118 can incorporate or associate additional/supplemental content, information, etc. For a particular communication (e.g., communication 430A) such supplemental content can include, for example, a user identifier (e.g., an account/profile name—here ‘User1’) associated with the user that provided the communication. Accordingly, in the scenario depicted in FIG. 4A, communication 430A can further include or be associated with a user identifier of user 130A (e.g., ‘User1’) while communication 430B can further include or be associated with a user identifier of user 130B (‘User2’).

Additionally, in certain implementations communication coordination engine 118 can associate various communication(s) with a particular application session (e.g., application session 150A and application session 150B as shown in FIG. 3). Each of the referenced application sessions can be, for example, a series or sequence of communications associated with a task, activity, transaction, etc. performed or facilitated by application 144A. By way of illustration, application session 150A can include communication(s) associated with a taxi ride of User1 to Downtown Seattle while application session 150B can include communications) associated with a taxi ride of User2 to SEA airport (as further illustrated below). In certain implementations, an identifier or indicator that corresponds to or reflects a particular application session can be associated with each related communication.

Associating communication(s) with a respective application session can be advantageous in scenarios such as are reflected in FIG. 3 and FIG. 4A. As shown, multiple communications, each of which can be associated with a different user, are received via a single interface (interaction engine 116). Additionally, such communications can pertain to different transactions, activities, etc. For example, communication 430A is associated with ‘User1’ and a taxi ride to ‘Downtown Seattle’ while communication 430B is associated with ‘User2’ and a taxi ride to ‘SEA airport’ (as further illustrated below). Accordingly, communication coordination engine 118 can, for example, associate communication 430A with application session 150A and communication 430B with application session 150B. Subsequent communications (e.g., those originating from application 144A or interaction engine 116) can also be associated with the referenced respective communication sessions. In doing so, consistency can be maintained with respect to subsequent operations, communications, etc. For example, a subsequent request received from User1 to change the destination of his/her ride can be processed/applied (e.g., by application 144A) to cancel/modify a prior request/communication associated with application session 150A. In doing so, such a request (e.g., from User1) will not affect operation(s) associated with application session 150B (e.g., a taxi ride to ‘SEA airport’ associated with ‘User2’). Accordingly, communication coordination engine 118 can ensure that consistency is maintained across multiple communications, even in scenarios in which such communications are received at a single interface from different users with respect to different transactions (and subsequently relayed to a single application).

As shown in FIG. 3, communication coordination engine 118 can transmit, provide, relay, etc. the referenced communications (e.g., communication 430A and communication 430B as shown in FIG. 4A) to server 140A. As noted above, server 140A can be a server on which the application referenced, identified, etc., in the received communication (e.g., ‘TaxiServiceApp’) is executing. In certain implementations, the referenced communications can be provided to/received by application extension engine 142A (which can also execute at server 140A, as noted above).

By way of illustration, application extension engine 142A can receive communication 430A and communication 430B from communication coordination engine 118 (e.g., via network 120). Application extension engine 142A can format such communications such that they can be provided to application 144A (here, ‘TaxiServiceApp’) in accordance with API 143A.

Upon receiving the referenced communications, application 144A (‘TaxiServiceApp’) in the scenario depicted in FIG. 4A) can generate other communication(s) (and/or other content). Such content/communication(s) generated by application 144A can be, for example, responses or follow-up communications which can provide content related to the initially received communications, prompt(s) that request additional information from the user(s), etc.

By way of illustration, in the scenario depicted in FIG. 4A, upon receiving initial communication(s) that various users (e.g., ‘User1’ and ‘User2’) each wish to order a taxi ride, application 144A can respond with various communications/content. Such responses can differ with respect to the particular communications to which they respond, as described below. Such response(s) from application 144A can then be provided back to application extension engine 142A in accordance with API 143A. Application extension engine 142A can then transmit or provide the referenced responses (from application 144A) to communication coordination engine 118. Communication coordination engine 118 can provide the received communication to interaction engine 116 (e.g., an intelligent personal assistant, chat interface, etc.) within which the communication can be presented/provided.

By way of illustration, FIG. 4A depicts communication 430C which can include message(s), content, and/or other items presented/provided within interaction engine 416. As described above, various elements of communication 430C can originate from application 144A (here, ‘TaxiServiceApp’), e.g., in response to communications 430A and 430B. For example, as shown in FIG. 4A, communication 430C can include text content 432B (‘we are locating . . . ’) which is directed to ‘User1’ (e.g., in response to communication 430A). Such text content 432B can, for example, confirm that the request provided by User1 (e.g., in communication 430A) has been received and is being processed (e.g., by application 144A).

Additionally, in certain implementations communication 430C can also include text content 432C (‘Please provide . . . ’) which is directed to ‘User2’ (e.g., in response to communication 430B). In certain implementations, communication 430C can also include additional elements such as input field 434B and selectable control 438B through which a user (e.g., ‘User2’) can provide additional inputs, as described above. For example, having received communication 430B from ‘User2,’ application 144A can prompt or request additional information (e.g., for the destination to which the user wishes to travel). Such information can be provided by the user via input field 434B and selectable control 438B, as shown. In doing so, another communication (corresponding such interaction/selection) can be generated and provided to application 144A (e.g., via communication coordination engine 118 and application extension engine 142A, as described above).

Upon receiving the referenced additional inputs (e.g., a trip destination from ‘User2’—here, ‘SEA airport,’ as shown in FIG. 4A), application 144A can generate and provide subsequent communication(s). Such communications(s) can then be relayed back to interaction engine 116 via application extension engine 142A and communication coordination engine 118, as described above. For example, FIG. 4B depicts an example scenario in which communication 430C is provided to ‘User1’ and ‘User2’ via interaction engine 416. As shown in FIG. 4B, communication 430C can include text content (e.g., content 432D and 432E) that reflects aspects of the respective trips associated with ‘User1’ and ‘User2’ (e.g., fare estimate, trip status, etc.). Additionally, communication 430C (as presented in interaction engine 116) can include selectable controls 438C and 438D which can enable the users to cancel, modify, etc. their respective trips, as shown.

It can therefore be appreciated that the described technologies (e.g., communication coordination engine 118 and application extension engine 142A) enable user 130 to access functionality, features, etc. of application 144A via interaction engine 116 (e.g., an intelligent personal assistant, chat interface, etc.). Additionally, the described technologies can ensure that consistency is maintained across multiple communications, even in scenarios in which such communications are received at a single interface from different users with respect to different transactions (and subsequently relayed to a single application).

While many of the examples described herein are illustrated with respect to a single device 110 and/or server (e.g., server 140A), this is simply for the sake of clarity and brevity. However, it should be understood that the described technologies can also be implemented (in any number of configurations) across multiple servers and/or other computing devices/services.

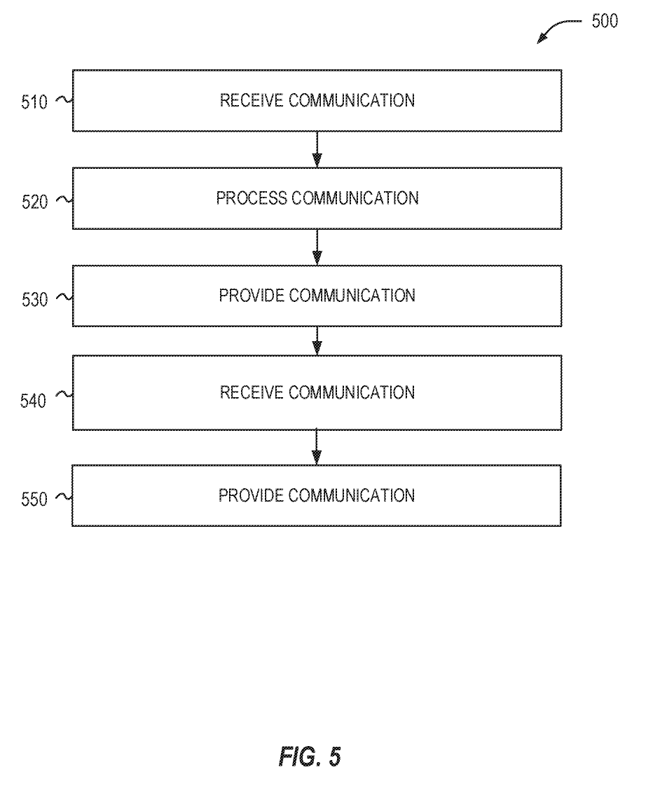

FIG, 5 is a flow chart illustrating a method 500, according to an example embodiment, for extending application functionality via conversational interfaces. The method is performed by processing logic that can comprise hardware (circuitry, dedicated logic, etc.). software (such as is run on a computing device such as those described herein), or a combination of both. In one implementation, the method 500 is performed by one or more elements depicted and/or described in relation to FIG. 1 (including but not limited to device 110 and/or communication coordination engine 118), while in some other implementations, the one or more blocks of FIG. 5 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

At operation 510, a first communication is received. In certain implementations, such a communication can be received from interaction engine 116 (e.g., as depicted in FIG. 1 and described above). Interaction engine 116 can be an intelligent personal assistant or messaging/communication application through which communications (e.g., messages, content, etc.) can be sent/received (e.g., to/from user 130). For example, as shown in FIG. 2A, user 130 (‘User1’) can provide or input communication/message 230A (“I want to order a ride . . . . ”) to interaction engine 216. The interaction engine (e.g., PDA, chat interface, etc.) can then provide communication 230A to communication coordination engine 118. As noted above, in certain implementations communication coordination engine 118 can receive the referenced communication in accordance with an API associated with the interaction engine(e.g., a chat/messaging API). In certain implementations, various aspects of operation 510 (as well as the other operations described with respect to FIG. 5) are performed by device 110 and/or communication coordination engine 118 (e.g., as depicted in FIG. 1). In other implementations, such aspects can be performed by one or more other elements/components, such as those described herein.

At operation 520, the first communication (e.g., as received at operation 510) is processed. In certain implementations, the communication can be parsed, analyzed, etc. to identify an application (or applications) that the first communication is directed to (e.g., using natural language processing and/or other such content processing techniques). For example, as shown in FIG. 2A, communication 230A can be processed to extract/identify content element(s) that correspond to an application, service, etc., that the user wishes to access, initiate, launch, etc.

As noted above, in certain implementations, the identified application(s) can be associated with application extension engine(s) (e.g., application extension engines 142A and 142B, as shown in FIG. 1). Such application extension engine(s) can extend various capabilities, functionality, etc., of the application to which the referenced communication is directed. For example, application extension engine 142A can enable communication(s) originating from sources/contexts such as interaction engine 116 to he provided to application 144A. The application extension engine can also enable communication(s) originating from the corresponding application (e.g., application 144A) to be provided to other applications (such as interaction engine 116), as described herein.

Moreover, in certain implementations the referenced communication (e.g., the communication received at operation 510) can be processed to identify a user that the communication is associated with (e.g., a user from which the communication originated from and/or otherwise pertains to). For example, as described above (e.g., with respect to FIG. 3), interaction engine 116 can be an intelligent personal assistant that receives voice/audio communications from various users. Accordingly, interaction engine 116 can receive communication(s) (e.g., audio/voice inputs) from user 230A and process such inputs (e.g., using audio processing techniques) to determine the identity of the user (e.g., a user account/profile associated with the user).

Additionally, in certain implementations the referenced communication can be associated with an application session (e.g., an application session of the first application). Such an application session can be a series/sequence of communications associated with a task, activity, transaction, etc. performed or facilitated by an application (e.g., application 144A). For example, as described above, communication coordination engine 118 can associate an application session (e.g., a corresponding identifier or indicator) to communication(s) that pertain to a particular transaction, task, etc. (e.g., a taxi ride). In doing so, consistency across multiple communications can be maintained even in a scenario in which multiple users (e.g., users 130A and 130B of FIG. 3) utilize a single interface (interaction engine 116) to conduct different transactions (e.g., order separate taxi rides) with respect to the same application (application 144A).

At operation 530, the communication (e.g., the communication received at operation 510) is provided. In certain implementations, the communication can be provided to an application extension engine, such as is associated with the application to which the referenced communication is directed. As describe above, such application extension engine(s) can extend various capabilities, functionality, etc., of the application to which the referenced communication is directed.

Additionally, in certain implementations, various supplemental content can be incorporated into the first communication (and provided to the application referenced application extension engine). Such supplemental content can be content, information, etc., that is not initially included in the communication (e.g., as received from the user). For example, information such as various specifications of the device 110 (e.g., model number), a user account/profile associated with the user, a state of the device (e.g., the current location of device and/or other sensor information), etc. can be incorporated into or associated with the referenced communication, as described above. In doing so, subsequent communications can be enhanced and/or streamlined (e.g., by providing content appropriately formatted for the device).

Moreover, in certain implementations the referenced supplemental content can further include various selections or determinations that can be computed, e.g., in conjunction with providing the referenced communication. For example, in certain implementations a determination can be made to provide/supply user profile data (e.g., in conjunction with the referenced communication). By way of further example, a determination can be made to anonymize various identifying information (e.g., user ID, etc.) associated with the user (e.g., based on a selection/preference previously provided by the user). By way of yet further example, a determination can be made to select another network connection and/or to utilize an alternative communication protocol (e.g., SMS) in a scenario in which device 110 loses network connectivity.

At operation 540, a second communication is received. In certain implementations, such a communication can be received from an application extension engine. Additionally, in certain implementations such a second communication can be associated with or directed to the first user (e.g., the user from which the first communication originated). For example, as shown in FIG. 1, application 144A can provide a response or follow-up communication which includes content related to the initially received communication, requests additional information from the user. etc. As described above, such a response from application 144A can then be to application extension engine 142A and further relayed to communication coordination engine 118.

Moreover, in certain implementations the second communication can include various content item(s). For example, as shown in FIG. 2A, communication 230B can include content items such as text content 232B, input field 234B (e.g., form within which text or other inputs can he provided), multimedia. content 236B (e.g., images, video, etc.), and a selectable control 238B (e.g., a button that a user can interact with, activate, etc.).

Additionally, in certain implementations the second communication can be associated with a second application session of the first application. For example, as described above, various communications (e.g., those pertaining to different transactions) can be associated with different application sessions. Accordingly, various communications received by communication coordination engine 118 can be associated with different application sessions (e.g., as depicted in FIG. 3 and FIG. 4A and described herein).

At operation 550, the second communication (e.g., as received at operation 540) is provided to the interaction engine. In certain implementations, such a second communication can be provided to the interaction engine in accordance with a with an API associated with the interaction engine (e.g., a chat/messaging API). For example, a response received from application 144A can be formatted in accordance with API 117 (e.g., a conversational API) and provided to interaction engine 115 (e.g., an intelligent personal assistant, chat interface, etc.).

Additionally, in certain implementations a content item can be provided to the interaction engine based on a. determination that a device at which the interaction engine executes can present the first content item. For example, as shown in FIG. 2A, communication 230B can include content items such as multimedia content 236B. Such a content item can be provided (e.g., to interaction engine 216) based on a determination that device 110 (and/or interaction engine 216) can provide/present such content. However, in a scenario in which it is determined, for example, that the interaction engine/device is not capable of presenting the content item (e.g., a device that can only present text content but not images/video), such multimedia content 236B may not be provided.

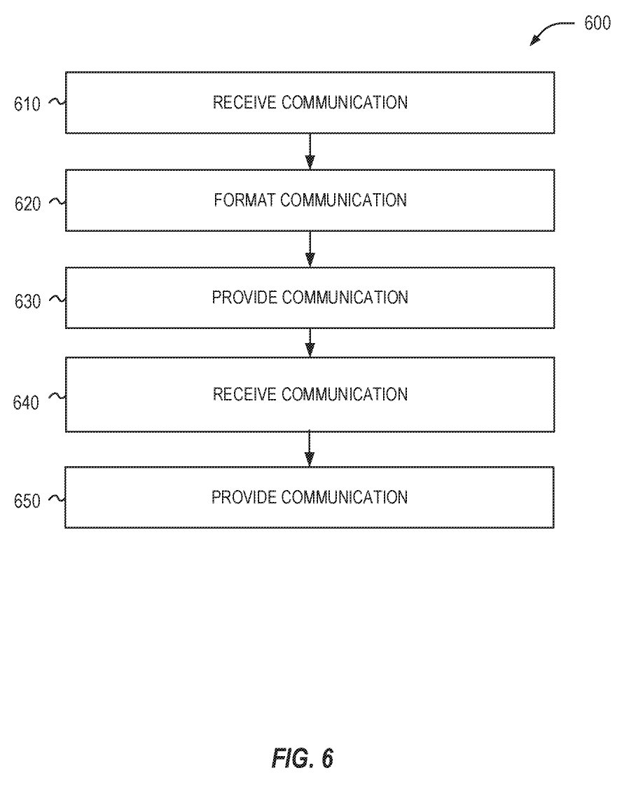

FIG. 6 is a flow chart illustrating a method 600, according to an example embodiment, for extending application functionality via conversational interfaces. The method is performed by processing logic that can comprise hardware (circuitry, dedicated logic, etc.), software (such as is run on a computing device such as those described herein), or a combination of both. In one implementation, the method 600 is performed by one or more elements depicted and/or described in relation to FIG. 1 (including but not limited to server 140A and/or application extension engine 142A), while in some other implementations, the one or more blocks of FIG. 6 can be performed by another machine or machines.

At operation 610, a first communication is received. In certain implementations, such a communication can originate from an interaction engine (e.g., a conversational interface) and/or can be directed to an application. For example, as shown in FIG. 1 and FIG. 2A and described above, application extension engine 142A can receive communication 230A which originated from interaction engine 216 (and is directed to application 144A). In certain implementations, various aspects of operation 610 (as well as the other operations described with respect to FIG. 6) are performed by server 140A and/or application extension engine 142A (e.g., as depicted in FIG. 1). In other implementations, such aspects can be performed by one or more other elements/components, such as those described herein.

In certain implementations, such a communication can include various aspects, characteristics, etc. of a device from which the first communication originated. For example, communication coordination engine 118 can relay or otherwise provide a communication originating from interaction engine 116 (and directed to application 144A) to application extension engine 142A. As described in detail above, various supplemental content such as the current location of device 110, various specifications of the device (e.g., model number), a user account/profile associated with the user, etc. can be incorporated into or associated with the referenced communication.

At operation 620, the first communication (e.g., as received at operation 610) is formatted. In certain implementations, such a communication can be formatted in accordance with an API of the application. For example, as described above with respect to FIG. 1 and FIG. 2A, application extension engine 142A can format communication 230A such that the communication can be provided to application 144A (here, ‘TaxiServiceApp’) in accordance with API 143A.

At operation 630, the first communication, as formatted in accordance with the API (e.g., at operation 620) is provided to the application, as described herein.

At operation 640, a second communication is received. In certain implementations, such a communication can be received from the application. For example, as shown in FIG. 1, application 144A can provide a response or follow-up communication which includes content related to the initially received communication, requests additional information from the user, etc.

Additionally, in certain implementations the second communication can include content that is compatible with the one or more aspects, characteristics, etc. of the device from which the first communication originated. For example, as noted above, the first communication (e.g., as received at operation 610) can incorporate various aspects of the referenced device (e.g., whether or not the device can present media content, etc.). Accordingly, the second communication can include content that is compatible with such a device, as described above.

At operation 650, the second communication is provided in response to the first communication, e.g., as described above.

It should also be noted that while the technologies described herein are illustrated primarily with respect to extending application functionality via conversational interfaces, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a. particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor- implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-6 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while vet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 7 is a block diagram illustrating components of a machine 700, according to some example implementations, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein can be executed. The instructions 716 transform the general, non-programmed machine into a particular machine programmed to carry out the described and illustrated functions in the manner described. In alternative implementations, the machine 700 operates as a standalone device or can be coupled (e.g., networked) to other machines. In a networked deployment, the machine 700 can operate in the capacity of a server machine or a client machine in a server-client network environment, or as a peer machine in a peer-to-peer (or distributed) network environment. The machine 700 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 can include processors 710, memory/storage 730, and I/O components 750, which can be configured to communicate with each other such as via a bus 702. In an example implementation, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 712 and a processor 714 that can execute the instructions 716. The term “processor” is intended to include multi-core processors that can comprise two or more independent processors (sometimes referred to as “cores”) that can execute instructions contemporaneously. Although FIG. 7 shows multiple processors 710, the machine 700 can include a single processor with a single core, a single processor with multiple cores (e.g., a multi-core processor), multiple processors with a single core, multiple processors with multiples cores, or any combination thereof.

The memory/storage 730 can include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 can also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions (e.g., instructions 716) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine (e.g., processors 710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 can include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 can include many other components that are not shown in FIG. 7. The I/O components 750 are grouped according to functionality merely for simplifying the following discussion and the grouping is in no way limiting. In various example implementations, the I/O components 750 can include output components 752 and input components 754. The output components 752 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/0 components 750 can include biometric components 756, motion components 758, environmental components 760, or position components 762, among a wide array of other components. For example, the biometric components 756 can include components to detect expressions (e.g., hand expressions, facial expressions, vocal expressions, body gestures, or eve tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 can include acceleration sensor components (e.g., accelerometer), gravitation sensor components, rotation sensor components (e.g., gyroscope), and so forth. The environmental components 760 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 762 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 750 can include communication components 764 operable to couple the machine 700 to a network 780 or devices 770 via a coupling 782 and a coupling 772, respectively. For example, the communication components 764 can include a network interface component or other suitable device to interface with the network 780. In further examples, the communication components 764 can include wired communication components, wireless communication components, cellular communication components. Near Field Communication (NFC) components, Bluetooth® components (e.g., Bluetooth® Low Energy), Wi-Fi® components, and other communication components to provide communication via other modalities. The devices 770 can be another machine or any of a wide variety of peripheral devices (e.g., a peripheral device coupled via a USB).

Moreover, the communication components 764 can detect identifiers or include components operable to detect identifiers. For example, the communication components 764 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and. other optical codes), or acoustic detection components (e.g., microphones to identify tagged audio signals). In addition, a variety of information can be derived via the communication components 764, such as location via Internet Protocol (IP) geolocation, location via Wi-Fi® signal triangulation, location via detecting an NFC beacon signal that can indicate a particular location, and so forth.

In various example implementations, one or more portions of the network 780 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 can include a wireless or cellular network and the coupling 782 can be a Code Division Multiple Access (CDMA) connection, a Global System for Mobile communications (GSM) connection, or another type of cellular or wireless coupling. In this example, the coupling 782 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks. Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 can be transmitted or received over the network 780 using a transmission medium via a network interface device (e.g., a network interface component included in the communication components 764) and utilizing any one of a number of well-known transfer protocols (e.g., HTTP), Similarly, the instructions 716 can be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

Throughout this specification, plural instances can implement components, operations, or structures described as a. single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource, Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving a first communication from an interaction engine;
processing the first communication to identify a first application that the first communication is directed to;
providing the first communication to an application extension engine associated with the first application;
receiving a second communication from the application extension engine; and
providing the second communication to the interaction engine.

2. The system of claim 1, wherein processing the first communication comprises processing the first communication using natural language processing to identify the first application that the first communication is directed to.

3. The system of claim 1, wherein processing the first communication comprises identifying one or more applications that are associated with one or more respective application extension engines.

4. The system of claim 1, wherein processing the first communication comprises processing the first communication to identify a first user that the first communication is associated with.

5. The system of claim 4, wherein the second communication is associated with the first user.

6. The system of claim 1, wherein the first communication is associated with a first application session of the first application and wherein the second communication is associated with a second application session of the first application.

7. The system of claim 1, wherein providing the first communication comprises:
incorporating supplemental content into the first communication; and
providing the first communication with the supplemental content to the application extension engine.

8. The system of claim 7, wherein the supplemental content comprises a state of a device at which the interaction engine executes.

9. The system of claim 1, wherein the second communication comprises a first content item, and wherein providing the second communication comprises providing the first content item to the interaction engine based on a determination that a device at which the interaction engine executes can present the first content item.

10. The system of claim 1, wherein receiving a first communication comprises receiving the first communication in accordance with a conversational application programming interface (API).

11. The system of claim I, wherein providing the second communication comprises providing the second communication to the interaction engine in accordance with a conversational API.

12. A method comprising:
receiving a first communication from an interaction engine;
processing the first communication to identify a first application that the first communication is directed to;
providing the first communication to a first application extension engine associated with the first application;
receiving a second communication from a second application extension engine associated with a second application; and
providing the second communication to the interaction engine.

13. The method of claim 12, wherein processing the first communication comprises processing the first communication to identify a first user that the first communication is associated with.

14. The method of claim 12, wherein providing the first communication comprises:
incorporating supplemental content into the first communication; and
providing the first communication with the supplemental content to the first application extension engine.

15. The method of claim 12, wherein the second communication comprises a first content item, and wherein providing the second communication comprises providing the first content item to the interaction engine based on a determination that a device at which the interaction engine executes can present the first content item.

16. The method of claim 12, wherein receiving a first communication comprises receiving the first communication in accordance with a conversational API.

17. A non-transitory computer readable medium having instructions stored thereon that, when executed by a processing device, cause the processing device to perform operations comprising:
receiving a first communication directed to an application;
formatting the first communication in accordance with an API of the application;
providing the first communication, as formatted in accordance with the API, to the application;
receiving, from the application, a second communication; and
providing the second communication in response to le first communication.

18. The computer-readable medium of claim 17, wherein the first communication originates from an interaction engine.

19. The computer-readable medium of claim 17, wherein the first communication comprises one or more aspects of a device from which the first communication originated.

20. The computer-readable medium of claim 19, wherein the second communication comprises content that is compatible with the one or more aspects of the device from which the first communication originated.
